(19) United States
(12) Patent Application Publication
(10) Pub. No.: US 2025/0020775 A1
(43) Pub. Date: Jan. 16, 2025

(54) METHOD OF ANALYZIING AND CORRECTING A COMPLEX WAVEFORM BY REAL AND IMAGINARY PARTITIONING AND RECOMBINATION

(71) Applicant: The Government of the United States, as represented by the Secretary of the Air Force, Wright-Patterson AFB, OH (US)

(72) Inventors: Trevor Bihl, Wheelersburg, OH (US); Anthony Baietto, Columbus, OH (US); Aaron Jones, Oakwood, OH (US); Jayson Boubin, Endwelly, NY (US)

(21) Appl. No.: 18/418,585

(22) Filed: Jan. 22, 2024

Related U.S. Application Data
(60) Provisional application No. 63/481,025, filed on Jan. 23, 2023.

(51) Int. Cl. G01S 7/41; G01S 13/28

(52) U.S. Cl. CPC G01S 7/417; G01S 13/282

(57) ABSTRACT

A method of analyzing and correcting a complex dynamic waveform, such as a radar wave or communication wave. The method comprises dividing a complex waveform into its real and imaginary components, then separately analyzing each such waveform in a dedicated neural to determine respective real and imaginary loss functions as the difference between the actual characteristics and desired characteristics of the mean squared error and at least one of frequency-domain power, time-domain envelope, and frequency-domain phase. The real waveform and imaginary waveform are independently corrected, then recombined into a single corrected complex waveform. These differences are fed into a neural network to improve prediction correction to bring the actual waveform closer to a benchmark waveform. The method of the present invention displays increased accuracy over the prior art without increased computing time or sacrificing notch depth.

### CROSS REFERENCE TO RELATED APPLICATION

This application claims priority to and the benefit of U.S. application Ser. No. 63/481,025 filed Jan. 23, 2023, the disclosure of which is incorporated herein by reference.

### STATEMENT OF GOVERNMENT INTEREST

The invention described and claimed herein may be manufactured, licensed and used by and for the Government of the United States of America for all government purposes without the payment of any royalty.

### FIELD OF THE INVENTION

The present invention is related to a method of analyzing, tuning and correcting a complex waveform and more particularly to such a method which separately treats the real waveform and imaginary waveform.

### BACKGROUND OF THE INVENTION

A neural network is a machine learning process that uses interconnected nodes or neurons in a layered structure that resembles the human brain. Three common types of neural networks are Artificial Neural Networks (ANN), Convolutional Neural Networks (CNN) and the commonly used Recurrent Neural Networks (RNN). Neural networks solve problems that require pattern recognition. One of the most well-known neural networks is Google's search algorithm.

Neural networks are comprised of an input layer, a hidden layer or layers, and an output layer. Data are usually fed into these models to train them, and they are the foundation for computer vision, natural language processing and other neural networks.

CNNs are similar to ANNs and may be used for image recognition, pattern recognition, and/or computer vision. CNNs harness principles from linear algebra, particularly matrix multiplication, to identify patterns within an image. The hidden layers in CNNs perform specific mathematical functions, like summarizing or filtering, called convolutions. RNNs are identified by feedback loops. RNNs may use learning algorithms for time-series data to make predictions about future outcomes, such as stock market predictions or sales forecasting.

Each layer within a neural network is comprised of individual nodes, or artificial neurons, which are interconnected to the nodes/neurons of adjacent layers. The output of each node/neuron is the weighted sum of any nodes/neurons in the previous layer with a non-linear activation applied. Each node, or artificial neuron, then connects to another node/neuron and has an associated weight and threshold. If the output of any individual node is above the specified threshold value, that node is activated, sending the associated data to the next layer of the network. Whether or not data will be passed along to the next layer of the network depends upon the specific activation function being used. For example, if a Rectified Linear Unit (ReLU) activation function is used, and the weighted summation of the previous neurons is less than 0, the output of that neuron will be zero. Conversely, if a tanh activation function is used, and the weighted summation of the previous neurons is less than 0, the output of that neuron will be nonzero and likely approach −1.

Neural networks rely on training data to learn and improve accuracy over time. Once these learning algorithms are fine-tuned for accuracy, they are powerful tools in computer science and artificial intelligence allowing one of skill to classify and cluster data at high velocity.

During use, each node can be set as a linear regression model composed of input data, weights, a bias (or threshold), and an output. Weights and biases are determinable from training. Weights and biases may initially be randomly chosen, then when predictions are made based on those weights and biases, the difference between predictions and truth are compared, and an error value is computed. The weights and biases are then adjusted using a gradient descent procedure to reduce error. Training will terminate when simultaneous predictions on a holdout “validation” data set indicates overfitting, and the weights and biases that produced the minimum error on the validation data set are used for production use.

Artificial neural networks may continuously learn by using corrective feedback loops to improve their predictive analytics. Data may flow from the input node to the output node through many different paths in the neural network. But the only correct path is the one which maps the input node to the correct output node. To find this path, the neural network uses a feedback loop, which works as follows: 1. each node makes a guess about the next node in the path; 2. the neural network checks if the guess was correct, then nodes assign higher weight values to paths that lead to more correct guesses and lower weight values to node paths that lead to incorrect guesses and 3. for the next data point, the nodes make a new prediction using the higher weight paths and then repeat step 1.

ANNs may be used to improve waveforms, such as autonomous radar waveforms and telecommunication waveforms. Particularly waveforms may be tuned or corrected for interference mitigation as commonly occurs due to the consumer radio frequency [RF] spectrum. Previous attempts have looked at low size, weight and power [low SWaP] ANNs and neuromorphic computing. Software such as TensorFlow and Keras has been used. Yet other attempts to mitigate interference with desired waveforms include spectral notching and convex optimization.

But these attempts do not always provide the most accurate corrections and tuning to the waveform. Error predictions between the actual and desired waveforms are not optimally calculated in the prior art. If the predicted error is not accurate, the resulting correction will, likewise, be inaccurate. Subsequent attempts at correction will likewise be distorted by the fallacious error prediction.

Current waveform design algorithms rely upon online optimization for latency-sensitive problem analysis, as occurs with interference avoidance. As the RF spectrum saturates with interference-both ambient and intentional from potentially nefarious sources—the need increases for interference mitigation in order to maintain critical radar operations. For example, as IoT devices proliferate so does RF interference. Likewise, as terrorist threats increase, so does intentional radar jamming. The need for interference mitigation concomitantly and likewise increases.

For correction, output waveforms will have a relatively large mean notch depth, also known as null depth, in the pass band. And preferably there is no fluctuation in the pass band and the latter half of the waveform has a well defined roll off.

For example, the current state of the art approach for signal processing waveform design is Re-Iterative Uniform Weight Optimization Algorithm (RUWO), a convex optimization algorithm used to perform spectral nulling on transmitted waveforms in order to mitigate interference in cluttered radio-frequency (RF) environments. This algorithm produces high quality spectrally notched waveforms; however, but at the cost of lofty execution times which makes RUWO impractical for low size, weight, and power (SWaP) applications. Likewise, the Gerchberg-Saxton Error Reduction Algorithm (ERA) can provide highly accurate results, but at the expense of time, rendering such algorithm infeasible for most dynamic waveform interference mitigation.

But the complexity and lengthy convergence times of prior art algorithms are suboptimal. These prior art algorithms are infeasible for complex waveforms subjected to dynamic and unpredictable interference, due to the lengthy computing time and concomitant undue latency. Conversely, prior art low SWAP neural networks and neuromorphic computing hardware tradeoff computing time/latency and for precision. The prior art either provides either one of precision or low latency at the expense of the other.

For example, with autonomous radar waveform design each point of a waveform must not only be numerically correct, but also correct in relation to the other points of waveform. Accordingly, it is important to capture all aspects of the waveform in the neural network learning process.

Referring to FIG. 1, one attempted solution was to simply increase the depth of the neural networks, from one layer to three layers. But this attempt only improved cosine similarity 0.03% at a 6.5% latency penalty.

Clearly an approach is needed which overcomes the current tradeoff between latency and precision. Such an approach preferably improves the loss function, so that convergence between the desired waveform and actual waveform occurs with fewer iterations and greater accuracy.

### SUMMARY OF THE INVENTION

The present invention does not rely upon increased neural network size, as occurs in the prior art. Instead, the present invention incorporates the waveform characteristics under consideration directly into the loss function. This design choice of the present invention reinforces beneficial waveform qualities to better guide the neural network toward ideal outputs without the prior art tradeoff of fast inference, by minimizing model width and depth. Rather than performing a simple element-wise numerical comparison of the output vectors, the present invention constructs loss quantities that account for relations between different vector elements, capable of focusing on both the numerical output and the necessary characteristics of a successful waveform.

In one embodiment the invention comprises a method of tuning a complex waveform, the method comprising the steps of: selecting a first complex waveform having a first plurality of complex actual waveform characteristics and a first plurality of complex desired waveform characteristics; separating the first complex waveform into a real waveform and an imaginary waveform, the real waveform having a second plurality of real waveform characteristics and a second plurality of real desired characteristics, the imaginary waveform having a second plurality of imaginary real waveform characteristics and a second plurality of imaginary desired characteristics; separately analyzing the real waveform and the imaginary waveform using a neural network to determine real mean square error differences between the real actual waveform characteristics and the real desired waveform characteristics and to determine imaginary mean square error differences between the imaginary actual waveform characteristics and the imaginary desired waveform characteristics; adjusting the real waveform and adjusting the imaginary waveform, to thereby reduce at least one of the real mean square error differences and at least one of the imaginary mean square error differences; and combining the real waveform and the imaginary waveform to yield a modified complex waveform having at least one of improved real waveform characteristics and improved imaginary waveform characteristics.

### BRIEF DESCRIPTION OF THE DRAWINGS

FIG. 1 is a table of the tradeoffs between neural network layers, latency, cosine similarity and null depth.

FIG. 2 is a control diagram of a system according to the present invention.

FIG. 3 is a table of desired waveform characteristics and associated loss functions where Y and Y\hat{ } are target and neural network predicted waveforms in traditional coefficient representation, respectively, and Z and Z\hat{ } are the target and neural network predicted waveforms recombined into a complex waveform representation, respectively.

FIG. 4 is an exemplary architecture for one embodiment of the present invention.

FIG. 5A is an exemplary summing quadrature circuit.

FIG. 5B is an exemplary quadrature demodulation circuit.

FIG. 6 is a functional representation of the architecture of FIG. 4.

FIG. 7 is a table comparing correctness of convex optimization and the neural networks of the present invention.

FIG. 8 is a table comparing speed of convex optimization and the neural networks of the present invention.

FIG. 9 is a table comparing latency of convex optimization and the neural networks of the present invention.

FIG. 10 is a table comparing null depth of convex optimization and the neural networks of the present invention.

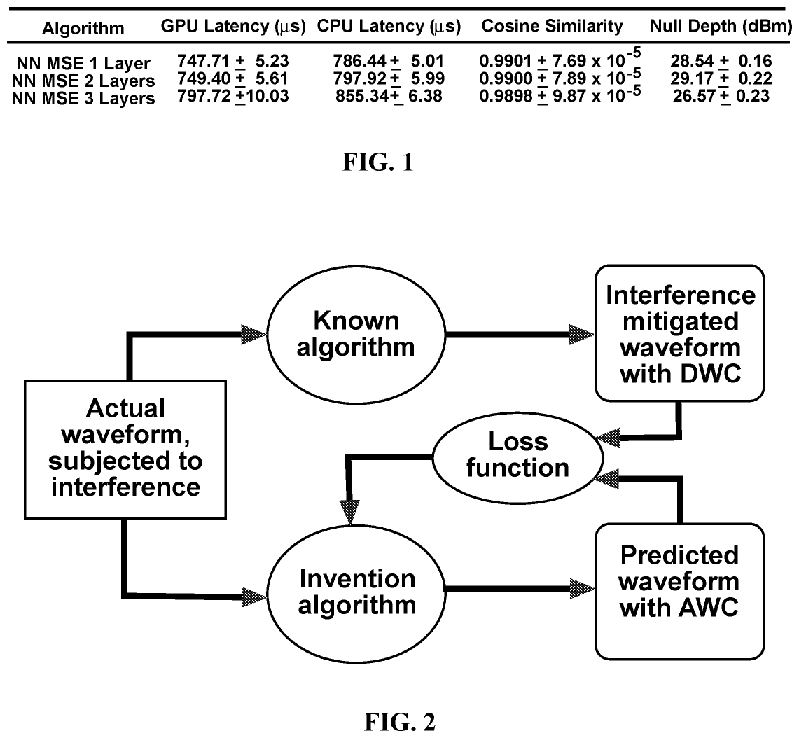

### DETAILED DESCRIPTION OF THE INVENTION

Referring to FIG. 2 a method according to the present invention operates on a system for generating, transmitting, receiving and often using on a waveform. Suitable waveforms include, but are not limited to, radar waveforms and communication waveforms. The waveform under consideration is believed to be subject to interference from ambient RF, etc. The waveform has actual waveform characteristics [AWC] and desired waveform characteristics [DWC] which are embedded in a neural network. The difference between the DWC and AWC represents an error in the actual waveform, typically due to improper- and/or insufficient training of the neural network. Plural differences between DWC and AWC may be appropriately summed into a loss function.

In the method according to the present invention, the actual waveform is compared to a desired waveform based upon one or more characteristics, as described below. The desired waveform may be determined using the Gerchberg-Saxton Error Reduction Algorithm, the RUWO algorithm or other highly accurate, but cumbersome, known algorithms. But such algorithms are infeasible for use with near real time correction of dynamic waveforms subjected to dynamic and changing interferences.

Instead of relying upon the cumbersome techniques of the prior art, the present invention uses neural networks to incrementally and iteratively correct and tune the prediction of the neural network and algorithm according to the present invention based upon the loss function with the intention that the loss function will approach zero after iterating.

Thus, the present invention overcomes the prior art tradeoffs by eliminating data pre-processing and pre-computing of the waveforms. Instead, the present invention uses one or more neural networks to operate directly on complex waveform characteristics to yield complex notched waveforms.

In a first embodiment, at least one, two, three and preferably four characteristics of the actual waveform [AWC] and a like number of corresponding characteristics of a desired waveform [DWC] are compared to find the difference therebetween. Again, the DWC are found using prior art high accuracy/high latency techniques and set a set as the benchmark for the DWC. It has been found that by comparing plural waveform characteristics in parallel in the same iteration, faster convergence is obtained without the prior art tradeoff of accuracy.

The first waveform characteristic to be considered is mean squared error [MSE], as is known in the art. MSE is generic to many fields and believed to be domain-agnostic, relying only upon comparisons/differences between the predicted output vector and target output vector. But in transformation settings, such as spectral notching, networks return higher-dimensionality results which may contain errors, only approximating correct results. MSE is given by:

$$\\ l ( y , \hat{y} ) = \frac{1}{n} {\sum }_{i = 1}^{n} {( {y}_{i} - {\hat{y}}_{i} )}^{2}$$

where Y is the desired characteristic and Y\hat{ } is the predicted characteristic.

Training a neural network with MSE to target RUWO waveforms asserts that RUWO is ideal and that the neural network should numerically mimic the RUWO outputs. RUWO outputs are represented as coefficient vectors: a representation that solely exists for algorithm compatibility and does not inherently contain any useful quantities, i.e., the numerical difference between the coefficient vectors of the neural network output and RUWO may not properly reflect the presence of desired waveform characteristics. Thus, without a relevant measure of waveform quality, there is little room for precise improvements. However, by implementing a custom loss function according to the present invention that includes these waveform characteristics, one of skill can prophetically exceed RUWO performance.

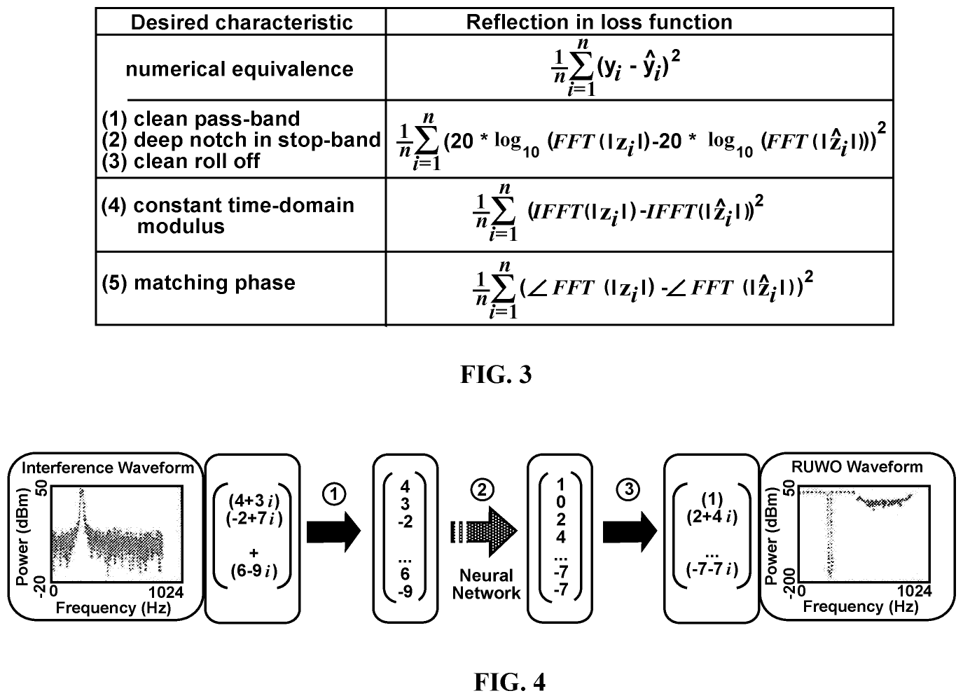

Referring to FIG. 3, one of skill can see that various waveform characteristics can be considered in the loss function. Particularly, the frequency domain power difference is given by:

$$\\ \frac{1}{n} {\sum }_{i = 1}^{n} {( 20 * {log}_{10} ( \vert {z}_{i} \vert ) - 20 * {log}_{10} ( \vert {\hat{z}}_{i} \vert ) )}^{2}$$

where Z and Z\hat{ } are the complex waveforms in the frequency domain, respectively and 20*log 10 (|Z|) and 20*log 10 (|Z\hat{ } |) are the actual frequency-domain power terms.

The time domain envelope difference is given by:

$$\\ \frac{1}{n} {\sum }_{i = 1}^{n} {( IFFT ( \vert {z}_{i} \vert ) - IFFT ( \vert {\hat{z}}_{i} \vert ) )}^{2}$$

where Z and Z\hat{ } are the where Z and Z\hat{ } are the complex waveforms in the frequency domain, respectively.

The frequency domain phase difference is given by:

$$\\ \frac{1}{n} {\sum }_{i = 1}^{n} {( ∠ \vert {z}_{i} \vert - ∠ \vert {\hat{z}}_{i} \vert )}^{2}$$

where Z and Z\hat{ } are the complex waveforms in the frequency domain, respectively and <(|Z|) and <(|Z|) are the actual frequency domain phase terms.

Combining all of these characteristics yields a preferred loss function according to:

$$\\ l ( y , \hat{y} ) = \frac{1}{2 n} {\sum }_{i = 1}^{2 n} {( {y}_{i} - {\hat{y}}_{i} )}^{2} + \frac{1}{n} {\sum }_{i = 1}^{n} {( 20 * {log}_{10} ( \vert {z}_{i} \vert ) - 20 * {log}_{10} ( \vert {\hat{z}}_{i} \vert ) )}^{2} + \frac{1}{n} {\sum }_{i = 1}^{n} {( IFFT ( \vert {z}_{i} \vert ) - IFFT ( \vert {\hat{z}}_{i} \vert ) )}^{2} + \frac{1}{n} {\sum }_{i = 1}^{n} {( ∠ \vert {z}_{i} \vert - ∠ \vert {\hat{z}}_{i} \vert )}^{2}$$

While a loss function which considers each of mean squared error, frequency domain power, time domain envelope and frequency domain phase is preferred, one of skill will recognize that the invention is not so limited. Three of these characteristics or even any tow of these characteristics may be used in a less preferred execution of the present invention.

Thus, according to the present invention, a dynamic waveform may be adjusted or advantageously tuned according to the following method. One of skill selects a waveform to be considered and having a first plurality of actual waveform characteristics [AWC] and a first plurality of desired waveform characteristics [DWC]. One then determines a mean square error difference between a first actual waveform characteristic [AWC] and a first desired waveform characteristic [DWC] at a first epoch, determines a frequency domain power difference between a first actual waveform characteristic [AWC] and a first desired waveform characteristic [DWC] at the first epoch. One then sums the mean square error difference and frequency domain power difference to yield a first epoch error loss function. Then one corrects the dynamic waveform based upon that first epoch error loss function.

According to the method one may further determine a frequency domain phase difference between a first actual waveform characteristic [AWC] and a first desired waveform characteristic [DWC] at the first epoch; and then sum the mean square error difference, frequency domain power difference and frequency domain phase difference to yield the first epoch error loss function. Alternatively or additionally, one may determine a time domain envelope difference between a first actual waveform characteristic [AWC] and a first desired waveform characteristic [DWC] at the first epoch; and then sum the mean square error difference, frequency domain power difference, frequency domain phase difference and time domain envelope difference to yield the first epoch error loss function.

Continuing the method, for further accuracy one may repeat the steps of determining the differences between the DWC and AWC for a second time epoch. Then one again sums the mean square error difference and frequency domain power difference to yield a second epoch error loss function; and subsequently corrects the dynamic waveform based upon the second epoch error loss function. One may particularly repeat these steps for the mean square error difference, frequency domain power difference, frequency domain phase envelope difference to yield a second epoch error loss function and then correct the dynamic waveform based upon the second epoch error loss function. Further one may repeat these steps for each of the mean square error difference, frequency domain power difference, frequency domain phase difference and time domain envelope difference to yield the second epoch error loss function; and then correct the dynamic waveform based upon the second epoch error loss function.

In a variant, one may determine which of the frequency domain power difference, frequency domain phase difference and time domain envelope difference is a greatest difference and then correct only the particular, respective characteristic of the waveform having that greatest difference. This method provides the benefit of further efficiency in computing.

According to an extension of this method, one may determine which of the frequency domain power difference, frequency domain phase difference and time domain envelope difference is the least difference. Then one corrects only those characteristics of the waveform not having that least difference. This is a hybrid method which provides the benefit of computing efficiency with greater accuracy than considering only the singular, greatest difference.

In another variant, one may employ a method of correcting each of the mean square error difference, frequency domain power difference, frequency domain phase difference and time domain envelope difference which exceeds a respective predetermined difference threshold. The threshold may be measured as a percentage of the respective DWC, such as 0.1%, 0.25%, 1%, 2% or any percentage therebetween.

In yet another variant, one may sum the mean square error difference, frequency domain power difference, frequency domain phase difference and time domain envelope difference at a plurality of epochs to yield a like plurality of epoch error loss functions. Then one may use a neural network to correct the dynamic waveform characteristic based upon the entirety of that plurality of epoch error loss functions.

One may perform serial correction by correcting the dynamic waveform characteristic after each epoch loss function of the plurality of epoch loss functions is determined. Or one may perform parallel correction by summing the plurality of epoch error loss functions to yield a summed error loss function; and then correcting the waveform based upon the summed error loss function. Such summation may include from 10 to 10000 and preferably 100 to 1000 epoch error loss functions.

Referring to FIG. 4, in an alternative embodiment the neural network may utilize a three-step architecture to convert input interference waveforms into transmittable notched waveforms. In a first step a complex signal is selected for consideration and converted to a coefficient vector compatible with a respective neural network pair. In a second step the coefficient vector is then fed through the neural network pair for adjustment and tuning to the predicted characteristics to yield a new coefficient vector. In a third step the new coefficient vector is converted back into a complex signal for further transmission and use.

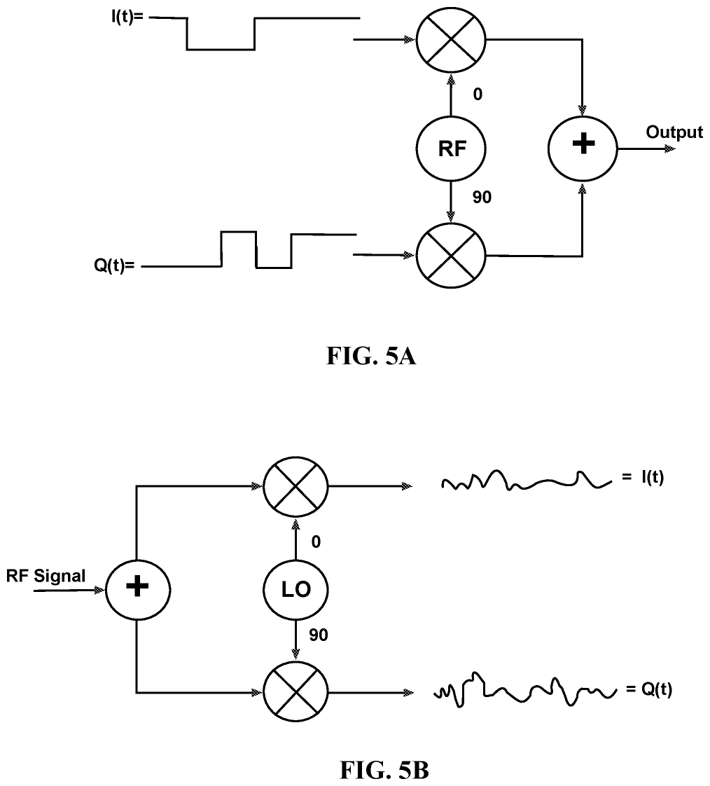

Referring to FIG. 5A and FIG. 5B and examining the invention in more detail, the selected waveform is a non-phased waveform, preferably a quadrature waveform although one of skill will recognize that the invention is not so limited. A pair of periodic signals are said to be in “quadrature” when they differ in phase by 90 degrees. The “in-phase” or reference signal is often referred to as “I,” and the signal that is shifted by 90 degrees (the signal in quadrature) is often referred to as “Q.” One example of a quadrature wave is the sine wave and the cosine wave in combination. If I=1 and Q=0, then one simply has the cosine wave (phase equal to 0). Similarly, if I=0 and Q=1, one simply has the sinewave, which is the 90 degree shifted signal. By convention, the cosine wave is in-phase component and the sine wave is the quadrature component. While a 90 degree phase shift is described below, one of skill will recognize any phase shift from 0 degrees to 180 degrees, preferably 80 degrees to 100 degrees, more preferably 88 to 92 degrees, still more preferably 89 to 91 degrees and most preferably 90 degrees.

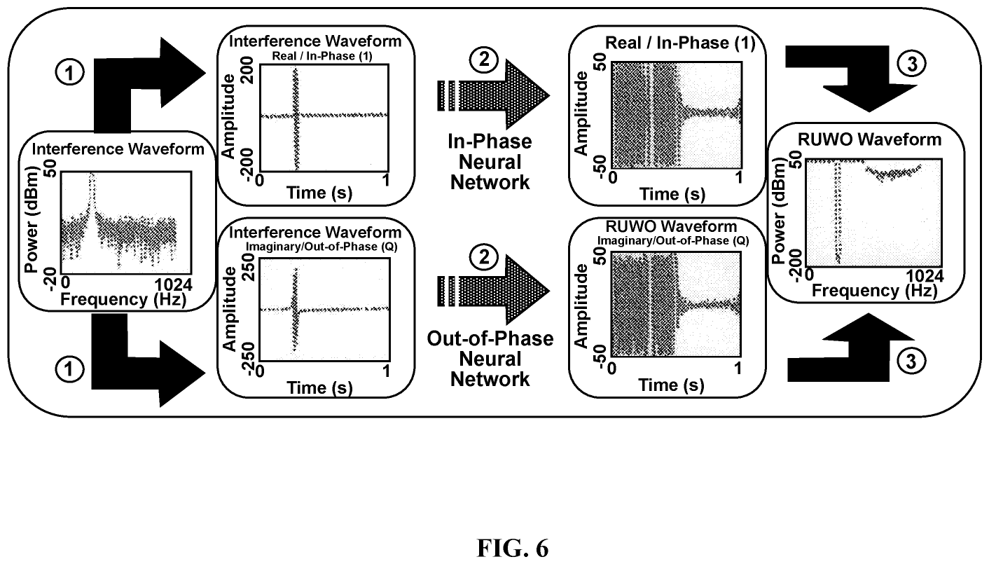

Referring to FIG. 6, the method of this embodiment comprises separating the complex signal into the two corresponding real signals that are fed into two different neural networks. The two neural networks may be identical for simplicity of construction or may be different for tailoring each neural network to the specific signal. Separating the two quadrature signals breaks the problem into designing a single real-valued waveform where a numerical element-wise comparison now corresponds with the quality of an object that exists beyond its representation, i.e., the real-valued signal has directly applicable qualities, and whereas the coefficient vector containing both quadrature signals does not. Each of these neural networks of the neural network pair then outputs the corresponding real signals which are then combined to form the final complex output signal.

The waveforms may be split and later recombined in the frequency domain for information compression. By keeping the real signals intact, the information pertaining to the waveform is advantageously and unexpectedly preserved throughout the network because the network is learning the problem in a manner that is advantageously independent of the data's representation.

This method more particularly comprises the steps of separating the complex waveform into an interference waveform having a real component and an imaginary component, separately analyzing the real component and the imaginary component to yield a first epoch error loss function and then recombining the real component and the imaginary component to yield a reiterative uniform weight optimization waveform.

Frequency domain power, frequency domain phase and time domain envelope only apply to the combined waveform, i.e. when the present in a complex format. While each of the real and imaginary components of the AWC and DWC is a waveform, the analysis only functions properly when the waveforms are combined into a complex format. It is desired that the frequency domain power, frequency domain phase and time domain envelope be as close to RUWO as reasonably possible.

The plural neural networks need not be independent. This method can also be used with a single neural network through which the real waveform and imaginary waveform are analyzed in series. Alternatively, one neural network may be duplicated and used in parallel with the original neural network. All such variations are within the scope of this embodiment, except as may be specifically claimed below.

This method can also utilize the steps of selecting a complex waveform having a first plurality of actual waveform characteristics and a first plurality of desired waveform characteristics, determining the mean square error difference according to:

$$\\ \frac{1}{2 n} {\sum }_{i = 1}^{2 n} {( {y}_{i} - {\hat{y}}_{i} )}^{2}$$

determining the frequency domain power difference according to:

$$\\ \frac{1}{n} {\sum }_{i = 1}^{n} {( 20 * {log}_{10} ( \vert {z}_{i} \vert ) - 20 * {log}_{10} ( \vert {\hat{z}}_{i} \vert ) )}^{2}$$

determining the time domain envelope according to:

$$\\ \frac{1}{n} {\sum }_{i = 1}^{n} {( IFFT ( \vert {z}_{i} \vert ) - IFFT ( \vert {\hat{z}}_{i} \vert ) )}^{2}$$

determining the frequency domain phase difference according to:

$$\\ \frac{1}{n} {\sum }_{i = 1}^{n} {( ∠ \vert {z}_{i} \vert - ∠ \vert {\hat{z}}_{i} \vert )}^{2}$$

then summing the mean square error difference, frequency domain power difference, time domain envelope difference and frequency domain phase difference to yield a first epoch error loss function; and correcting the dynamic complex waveform based upon that first epoch error loss function.

A method may determine the frequency domain phase difference and the time domain envelope difference as weighted by a frequency domain phase difference weight less than 1 and a time domain envelope difference weight less than 1, respectively. The frequency domain phase difference weight and the time domain envelope difference weight are mutually different. The frequency domain phase difference weight may be greater than the time domain envelope difference weight. By way of nonlimiting example, if the output of the neural network has, e.g. 85.0% similarity to RUWO for the real waveform and 84.8% similarity to RUWO for the imaginary waveform prior to implementing the method of this embodiment and 86.0% and 78% for the real and imaginary waveforms, respectively after implementing this method, then the training was unsuccessful and the neural network should be trained for another epoch.

The method may separate the complex waveform into an interference waveform having a real component and an imaginary component, separately analyze the real component to determine a real mean square error difference and the imaginary component to determine an imaginary mean square error difference. The next step is combining the real mean square error difference and the imaginary mean square error difference to yield a combined mean square error difference; and then summing the combined mean square error difference in the first epoch error loss function. The method may further comprise the steps of determining a plurality of combined mean square error differences and summing the plurality of combined mean square error differences in the first epoch error loss function.

The methods of tuning and correcting dynamic waveforms according to the first embodiment and the second embodiment of the invention were benchmarks against the known RUWO algorithm, ERA algorithm and MSE neural network [NN]. The data generation scripts were coded in MATLAB version 2021a. A sampling frequency of 1024 Hz with a transmit band-width of 512 Hz was used to generate a linear frequency modulated (LFM) interference signal matrix, which, in turn, was used as input for the ERA and RUWO algorithms as well as the neural networks. The dataset consisted of 262, 144 input LFM interference and corresponding output RUWO waveforms. Gaussian noise with an amplitude of 0.1 and variance 1 was used to provide variety in the training dataset. Data generation occurred on a standard memory node on a Mustang HPE SGI 8600 system, with a U.S. Air Force Research Laboratory (AFRL) DoD Supercomputing Resource Center (DSRC) machine, powered by dual Intel Skylake Xeon 8168 CPUs and 192 GB of RAM.

The neural network models were implemented in Python 3.6.8 using the Keras 2.3.1 library and the Tensorflow 2.2.0 machine learning back-end library. The Hyperas 0.4.1 library, a Hyperopt wrapper for Keras models, was selected for performing the hyperparameter optimization. Training occurred on a GPU node on the Mustang HPE SGI 8600 system, a U.S. Air Force Research Laboratory (AFRL) DoD Supercomputing Resource Center (DSRC) machine, powered by dual Intel Skylake Xeon 8168 CPUs, 384 GB of RAM, and a NVIDIA Tesla PI00 GPU for neural network acceleration. Trainable hyperparameters included layer depth, layer width, dropout rate, activation function, and the loss function. We used the tree-structured Parzen estimator (TPE) in Hyperas for hyperparameter optimization. The hyperparameters for all models were a network depth of 1 layer, a network width of 256 neurons, a dropoiut rate of 0.2 and tanh activation function. K-Fold cross-validation using 10 folds and cosine similarity to evaluate training progress where each training trial lasted for 100 epochs was performed.

For open air RFSOC trials, the algorithms were implemented using Simulink with MATLAB R2020a and the hardware description language (HDL) generation toolbox. The HDL code using Vivado v2019.1 which included optimized HDL-code blocks for functions such as FFT/IFFT and tanh was used. All tests were run on the Xilinx ZCUI 11 RFSOC with a FPGA clock rate of 128 MHz. Floating point values were not supported, so the weights and biases are quantized to signed 18-bit fixed point values before being sent to the RFSoC.

The input signals for the ERA, RUWO, and NN model implementations were received as a 1024 sample, 18 bit, 16 fractional signed complex fixed point inputs with a single interference band. This signal was generated using a LFM chirp that swept through a range of frequencies and appears as a band of interference in the frequency spectrum. After passing through the appropriate HDL-code blocks of our algorithms, the output is an interference mitigated signal with the same sample size and datatype ready for transmission back to the computer for analysis. RFSoC testing was performed on a FPGA using actual waveforms.

The second embodiment IQ models were implemented using the Keras functional API for more custom network architectures. Contained within these models were two neural networks that operate on the in-phase (real) and out-of-phase (imaginary) components of the waveform separately. These sub networks were run simultaneously, and each sub network used the same hyperparameters discussed above.

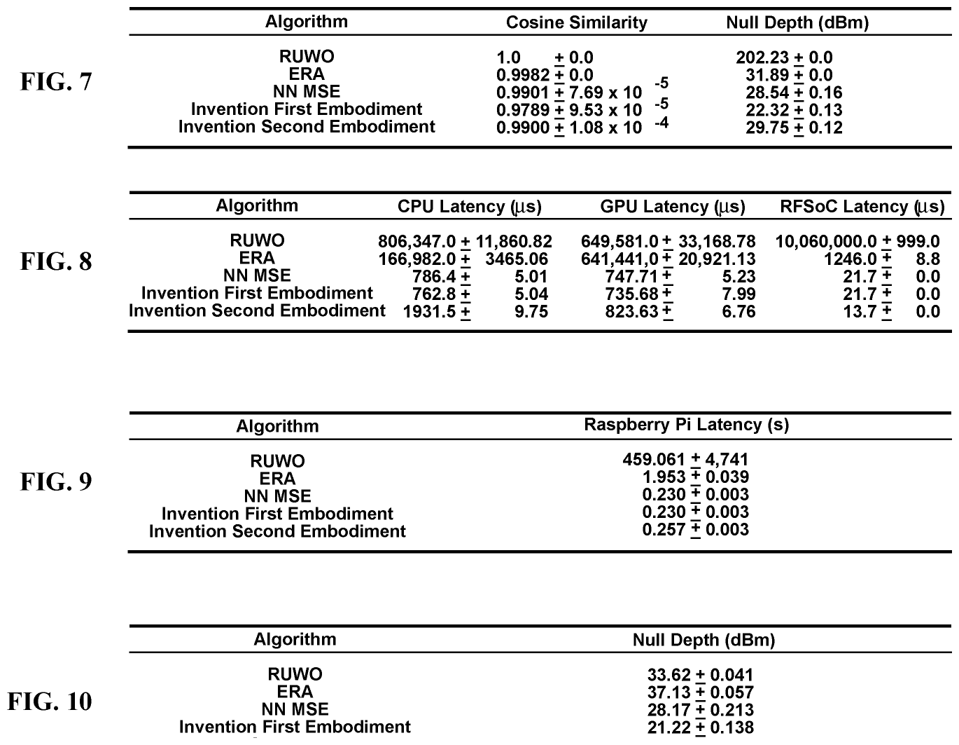

Referring to FIG. 7, the results show that both embodiments of neural networks according to the present invention operate within 2.2% cosine similarity compared to the RUWO algorithm and within 1.2% compared to the ERA algorithm. As the defining metric for spectral waveform quality, the null depth results show that both neural networks according to the present invention are capable of performing waveform design with more than satisfactory precision. Furthermore, neural network tailoring of both embodiments according to the present invention towards waveform design produced better performing networks that were able to improve over prior art networks in null depth by 4.24%.

Referring to FIG. 8, latency comparisons on multiple hardware accelerators, including the NVIDIA Tesla PI00 GPU and the Xilinx XZUIII RFSOC which utilizes an FPGA, demonstrated significant and unexpected speed increases over convex optimization. The portability of neural networks onto a variety of different hardware platforms, with little overhead, allows one of skill to broaden waveform design applications to spaces that would otherwise be impossible to implement due to time and power constraints, such as, but not limited to, mobile development.

Referring to FIG. 9, latency tests were run on the Raspberry Pi platform using the low-cost Raspberry Pi 3 Model B, with a quad core 1.2 GHz Broadcom BCM2837 64-bit CPU and 1 GB of LPDDR2 RAM, and only a small credit-card sized profile. Again, the neural networks according to the present invention delivered faster results that the prior art on both high-end accelerators and on low-end consumer-grade embedded hardware.

Referring to FIG. 10, notch depth tests were run using the RFSoC for open air trials to validate the simulation results. The training and testing data for the neural network development were generated using simulations. To demonstrate the robustness of the present invention, the RFSoC was used to physically transmit the interference waveforms in order to better test the present invention neural network solutions in a more practical environment and to compare the ERA and RUWO algorithms on physical hardware.

In the open air trials, it was found that the neural networks of the present invention created quality waveforms that conformed to the desired characteristics. Specifically, the present invention neural network produced waveforms with a notch depth within 17% compared to the RUWO algorithm. These results show that our neural network approach performs satisfactorily in both simulation and real-world application.

Furthermore while performing the open air trials, it was discovered that limitations with the RUWO algorithm implemented on the RFSOC hardware occurred. The FPGA hardware of the Xilinx XZUIII RFSOC requires all variables to be stored as fixed point values as opposed to traditional floating point storage found on CPU and GPU hardware. This restriction reduces the granularity of variable representation which, when coupled with the exceptionally high precision the RUWO algorithm expects, produces much lower quality waveforms. The neural network and ERA implementations did not reduce so drastically in quality from this hardware limitation and were able to produce waveforms consistent with their corresponding CPU/GPU implementations. Thus it was determined that neural networks according to the present invention have better resiliency to different hardware platforms than found in the prior art.

The foregoing tests demonstrate the effectiveness of the neural networks of the present invention as applied to the autonomous radar waveform design problem, particularly achieving speed increases of over 1000× with less than 2.2% drop in cosine similarity compared to the prior art, thereby showing the viability of the present invention applied to other radar and waveform design fields where the prior art attempts are also hindered by poor performance times. The effectiveness of the present invention further works on different specialized hardware, thus allowing easier portability to lower cost accelerators compared to the difficulty and cost of implementing prior art application-specific integrated circuits (ASICs). The present invention is also applicable to a wider array of applications where traditional algorithms would be inappropriate due to time or power constraints. For example, cars and low-power devices can now benefit from these radar applications running on native hardware and low-cost commercial “off-the-shelf” hardware.

One of skill will understand that the first embodiment described herein and the second embodiment described herein both use neural networks for processing of radar and communication waveforms, and more particularly design the higher order structure of the neural network. Both embodiments collect training data, select hyperparameters for the neural network, train the neural network(s) using training data and evaluate the neural network(s) using the training data. The hyperparameters may include any or all of the number of layers in the neural network(s), the number of neurons per layer and/or which activation function(s) are used.

All values disclosed herein are not strictly limited to the exact numerical values recited. Unless otherwise specified, each such dimension is intended to mean both the recited value and a functionally equivalent range surrounding that value. For example, a dimension disclosed as “40 mm” is intended to mean “about 40 mm.” Every document cited herein, including any cross referenced or related patent or application, is hereby incorporated herein by reference in its entirety unless expressly excluded or otherwise limited. The citation of any document or commercially available component is not an admission that such document or component is prior art with respect to any invention disclosed or claimed herein or that alone, or in any combination with any other document or component, teaches, suggests or discloses any such invention. Further, to the extent that any meaning or definition of a term in this document conflicts with any meaning or definition of the same term in a document incorporated by reference, the meaning or definition assigned to that term in this document shall govern. All limits shown herein as defining a range may be used with any other limit defining a range of that same parameter. That is the upper limit of one range may be used with the lower limit of another range for the same parameter, and vice versa. As used herein, when two components are joined or connected the components may be interchangeably contiguously joined together or connected with an intervening element therebetween. A component joined to the distal end of another component may be juxtaposed with or joined at the distal end thereof. While particular embodiments of the present invention have been illustrated and described, it would be obvious to those skilled in the art that various other changes and modifications can be made without departing from the spirit and scope of the invention and that various embodiments described herein may be used in any combination or combinations. It is therefore intended the appended claims cover all such changes and modifications that are within the scope of this invention.

What is claimed is:

1. A method of tuning a complex waveform, the method comprising the steps of:
selecting a first complex waveform having a first plurality of complex actual waveform characteristics and a first plurality of complex desired waveform characteristics;
separating the first complex waveform into a real waveform and an imaginary waveform, the real waveform having a second plurality of real waveform characteristics and a second plurality of real desired characteristics, the imaginary waveform having a second plurality of imaginary real waveform characteristics and a second plurality of imaginary desired characteristics;
separately analyzing the real waveform and the imaginary waveform using a neural network to determine real mean square error differences between the real actual waveform characteristics and the real desired waveform characteristics and to determine imaginary mean square error differences between the imaginary actual waveform characteristics and the imaginary desired waveform characteristics;
adjusting the real waveform and adjusting the imaginary waveform, to thereby reduce at least one of the real mean square error differences and at least one of the imaginary mean square error differences; and
combining the real waveform and the imaginary waveform to yield a modified complex waveform having at least one of improved real waveform characteristics and improved imaginary waveform characteristics.

2. A method according to claim 1 wherein the modified complex waveform has both improved real waveform characteristics and improved imaginary real waveform characteristics.

3. A method according to claim 2 wherein each real actual waveform characteristic of the second plurality of real actual waveform characteristics is improved.

4. A method according to claim 2 wherein each imaginary actual waveform characteristic of the second plurality of imaginary waveform characteristics is improved.

5. A method according to claim 2 wherein each real actual waveform characteristic of the second plurality of real waveform characteristics and each imaginary actual waveform characteristic of the second plurality of imaginary waveform characteristics is improved.

6. A method according to claim 1 wherein at least two of frequency-domain power, time-domain envelope and frequency domain phase are analyzed as complex waveforms.

7. A method of correcting a complex waveform, the method comprising the steps of:
selecting a first complex waveform having a first plurality of complex actual waveform characteristics and a first plurality of complex desired waveform characteristics;
separating the first complex waveform into a real waveform and an imaginary waveform, the real waveform having a second plurality of real waveform characteristics and a second plurality of real desired characteristics, the imaginary waveform having a second plurality of imaginary real waveform characteristics and a second plurality of imaginary desired characteristics, the real waveform and the imaginary waveform being mutually out of phase with the other;
separately analyzing the real waveform and the imaginary waveform using a neural network approach to determine real differences between the real actual waveform characteristics and the real desired waveform characteristics and to determine imaginary differences between the imaginary actual waveform characteristics and the imaginary desired waveform characteristics;
adjusting the real waveform and adjusting the imaginary waveform, to thereby reduce at least one of the real differences and at least one of the imaginary differences; and
combining the real waveform and the imaginary waveform to yield a modified complex waveform having at least one of improved real waveform characteristics and improved imaginary waveform characteristics.

8. A method according to claim 7 wherein the real waveform leads the imaginary waveform.

9. A method according to claim 7 wherein the imaginary waveform is 90+/−45 degrees out of phase relative to the real waveform.

10. A method according to claim 9 wherein the imaginary waveform is 90+/−5 degrees out of phase relative to the real waveform.

11. A method according to claim 9 wherein separately analyzing the real waveform and the imaginary waveform using a neural network approach comprises the steps of:
providing a first neural and a second neural network separate therefrom; and analyzing the real waveform with the first neural network and analyzing the imaginary waveform with the second neural network.

12. A method according to claim 11 wherein the first neural and the second neural network are mutually different.

13. A method according to claim 12 wherein the real waveform comprises a real component of an interfered waveform before analyzing with the first neural network and a real component of an interference mitigated waveform after analyzing with the first neural network and the imaginary waveform comprises an imaginary component of the interfered waveform before analyzing with the second neural network and an imaginary component of an interference mitigated waveform after analyzing with the second neural network.

14. A method according to claim 13 wherein the real actual waveform characteristics and the imaginary actual waveform characteristics include only mean squared error characteristics.

15. A method of tuning a complex waveform, the method comprising the steps of:
selecting an unmodified complex waveform having a first plurality of complex actual waveform characteristics and a first plurality of complex desired waveform characteristics;
separating the unmodified complex waveform into a real quadrature waveform and an imaginary quadrature waveform, the real quadrature waveform having a second plurality of real waveform characteristics and a second plurality of real desired characteristics, the imaginary quadrature waveform having a second plurality of imaginary real waveform characteristics and a second plurality of imaginary desired characteristics;
separately analyzing the real quadrature waveform and the imaginary quadrature waveform using a neural network approach to determine real differences between the real actual waveform characteristics and the real desired waveform characteristics and to determine imaginary differences between the imaginary actual waveform characteristics and the imaginary desired waveform characteristics;
adjusting the real quadrature waveform and adjusting the imaginary quadrature waveform, to thereby reduce at least one of the real differences and at least one of the imaginary differences; and
combining the real quadrature waveform and the imaginary quadrature waveform to yield a modified complex waveform having at least one of improved real waveform characteristics and improved imaginary waveform characteristics.

16. A method according to claim 15 wherein combining the real quadrature waveform and the imaginary quadrature waveform yields a modified complex waveform having both improved real waveform characteristics and improved imaginary waveform characteristics.

17. A method according to claim 16 wherein the step of using a neural network comprises the steps of:
providing a first neural and a second neural network separate therefrom and running simultaneously therewith; and analyzing the real waveform with the first neural network and analyzing the imaginary waveform with the second neural network, wherein each of the first neural network and the second neural network include plural real desired characteristics and plural imaginary desired characteristics of plural mean squared errors.

18. A method according to claim 17 further comprising the steps of:
assigning a real weight to each of the desired real characteristics and an imaginary weight to each of the desired imaginary characteristics; the real weight and the imaginary weight being mutually unequal.

19. A method according to claim 17 wherein the first neural network and the second neural network include hyperparameters selected from the group consisting of: layer depth, layer width, dropout rate, activation function, loss function and combinations thereof.

20. A method according to claim 15 wherein the modified complex waveform in an interference mitigated signal relative to the unmodified complex waveform.
